(19) United States
(12) Patent Application Publication
(10) Pub. No.: US 2010/0138766 A1
(43) Pub. Date: Jun. 3, 2010

(54) GRAVITY DRIVEN USER INTERFACE

(76) Inventor: Satoshi Nakajima, Medina, WA (US)

Correspondence Address: DINH & ASSOCIATES, 2506 ASH STREET, PALO ALTO, CA, 94306, US

(21) Appl. No.: 12/327,750

(22) Filed: Dec. 3, 2008

(51) Int. Cl. G06F 3/033; G06F 3/048

(52) U.S. Cl. 715/767; 715/863

(57) ABSTRACT

Methods, systems, and techniques for presenting user interface elements on display screens are provided, in particular smaller display screens such as those available with mobile telecommunications devices. Example embodiments provide a gravity-based user interface mechanism which causes a menus to be displayed or to disappear when the mechanism determines that the device has been tilted up or down. In some embodiments, the mechanism causes an undo or a redo operation to occur when a tilt of the side or the opposite side of the device downward is detected. In one embodiment, a tilt downward of the left side cause an undo, whereas a tilt downward of the right side causes a redo. This abstract is provided to comply with rules requiring an abstract, and it is submitted with the intention that it will not be used to interpret or limit the scope or meaning of the claims.

### TECHNICAL FIELD

The present disclosure relates to methods, systems, and techniques for user interface improvements and, in particular, to user interfaces for using accelerometer data.

### BACKGROUND

User interfaces on mobile devices such as cell phones, smart phones, PDAs, etc. are faced with limitations not necessarily present on larger more stationary devices such as personal computers. For example, the extremely small display screen size inherently limits how much a user can view on the display screen at any one time. Such limitations may be due in part to the scarceness of resources of the device such as battery life. Programmers of device software for such mobile devices may be encouraged to refrain from using system resources (for example, compute power behind a user interface) for too long.

In addition, sound user interface design principles caution from displaying too much at once to a user to limit the perceived crowdedness and visual noise caused by presenting too many objects at once to a user. As a result, user interfaces for such devices commonly present commands through multiple layers of menus, which require a user to learn them and possibly invoke many input “strokes” to accomplish a task.

Recent designs in user interfaces have made mobile devices such as Apple's® iPhone™ more user friendly by displaying content in portrait or in landscape mode in response to a user changing the orientation of a device from portrait to landscape and visa versa. While such features are useful, they do not address the problems of mobile devices described.

### BRIEF DESCRIPTION OF THE DRAWINGS

FIG. 1 is an example environment that illustrates various mobile devices presenting a mobile application with a user interface for use with the described GBUIM embodiments.

FIGS. 2A and 2B are an example illustration of an opening progression of a tilt-initiated menu user interface according to an example embodiment.

FIGS. 3A and 3B are an example illustration of a closing progression of a tilt-initiated menu user interface according to an example embodiment.

FIG. 4 is an example embodiment of the tilt-initiated menu interface of FIGS. 2A and 2B incorporated within the mobile application environment of FIG. 1.

FIG. 5 is an example schematic of tilt movements used to implement aspects of the menu user interface illustrated in FIGS. 2A, 2B, 3A, and 3B.

FIG. 6 is an example illustration of an initial user interface display of a mobile application for drawing.

FIG. 7 is an example illustration of a progression of a tilt-initiated user interface for implementing an undo operation.

FIG. 8 is an example illustration of a progression of a tilt-initiated user interface for implementing a redo operation.

FIG. 9 is an example schematic of tilt movements used to implement aspects of the undo/redo user interface of FIGS. 7 and 8.

FIG. 10 is an example block diagram of a mobile device or a computing system for practicing embodiments of a gravity-based user interface.

FIG. 11 is an example flow diagram of an example event handler for handling accelerometer events.

FIG. 12 is an example flow diagram of an example tilt up/down handler for implementing menus according to an example embodiment of a gravity-based user interface.

FIG. 13 is an example flow diagram of an example tilt left/right handler for implementing undo/redo operations according to an example embodiment of a gravity-based user interface.

### DETAILED DESCRIPTION

Embodiments described herein provide enhanced computing-based methods, systems, and techniques for implementing user interfaces on computing devices typically with small display screens, such as mobile devices. Example embodiments provide a gravity-based user interface mechanism (a “GBUIM”), which enables users to invoke user interface (UI) controls and capabilities using a “tilt” mechanism without having to display most, or even all, of the user interface controls on the display screen prior to making them available for use. This allows, for example, applications written for mobile devices to utilize the full display screen real estate for content that relates to their respective primary purposes without the clutter of user interface controls for manipulating such content.

Example embodiments operate in conjunction with accelerometer information, which provides substantially real-time or near real-time orientation information, to offer enhanced UI functionality. More specifically, according to one example embodiment, when the user tilts the mobile device up or down at varying levels (e.g., the top of the device viewed in portrait mode is rotated forward or backward), user interface controls may be presented, such as by overlaying or replacing the content currently displayed on the mobile device display screen. (This rotation may be thought of as rotation along a transverse axis, such as “pitch” in flight dynamics terms.) According to another example embodiment, when the user tilts the side of the mobile device in one direction at varying levels (e.g., left side down) or in the opposite direction (e.g., right side down), an undo or redo operation, respectively, may be performed. (This rotation may be thought of as rotation along a longitudinal axis, such as “roll” in flight dynamics terms.) In some embodiments, different operations may be invoked based upon the level of tilt. For example, a greater level of tilt may result in a repeated undo/redo. Levels of tilt may be expressed, for example, as degrees or percentage tilt (or using any other similar measurement of tilt) from a horizontal orientation to a vertical orientation. Note that in other embodiments, different UI functions may be invoked as a result of these tilting operations.

Although any mechanism for providing near real-time orientation information may be used with the techniques described here to present a GBUIM, example embodiments are described as obtaining orientation data from an accelerometer device, which measures acceleration and gravity induced reaction forces typically in units of gravity (“g”s). Near real-time orientation (e.g., inclination) data can be extracted from the acceleration data. Accelerometers are increasingly available on mobile devices to provide data that can be incorporated into mobile applications. For example, they have been used in devices that implement game controllers or other portable electronic devices. Accelerometers have also been incorporated as part of cellular phones and smart phones, in order to provide enhanced location and/or orientation data to applications developed for such phones. One such accelerometer is present in iPhone™ devices manufactured by Apple Corporation, and its data is accessible using Apple's standard SDK (software development kit) available from Apple Corp. Other known and available accelerometers (such as an LIS302DL from STMicroelectionics) may be used.

Also, although the examples described herein often refer to a mobile device such as a smart phone, the techniques described herein can also be used by other types of mobile devices. Accordingly, for the purposes herein, mobile devices may include devices such as cellular telephones, smart phones, personal digital assistants (“PDAs”), gaming consoles, portable electronic devices, other mobile devices with integrated display screens, standalone display screens controlled by remote mobile devices, etc. Also, the examples described herein describe the presentation of user interfaces having user interface controls (UI controls), although interfaces having different sorts of interaction mechanisms (e.g., such as voice commands) may also be invoked or caused to be presented using the GBUIM techniques described here.

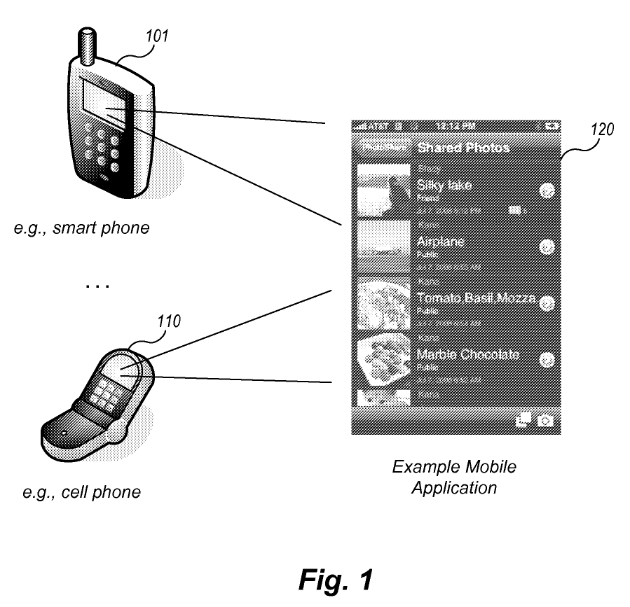

FIG. 1 is an example environment that illustrates various mobile devices presenting a mobile application with a user interface for use with the described GBUIM embodiments. In FIG. 1, smart phone 101 and/or cellular phone 110 are indicated as displaying example mobile application 120 on their (small) display screens. Example GBUIMs, as will be described in more detail, can be used with example mobile application 120 to enhance the user experience.

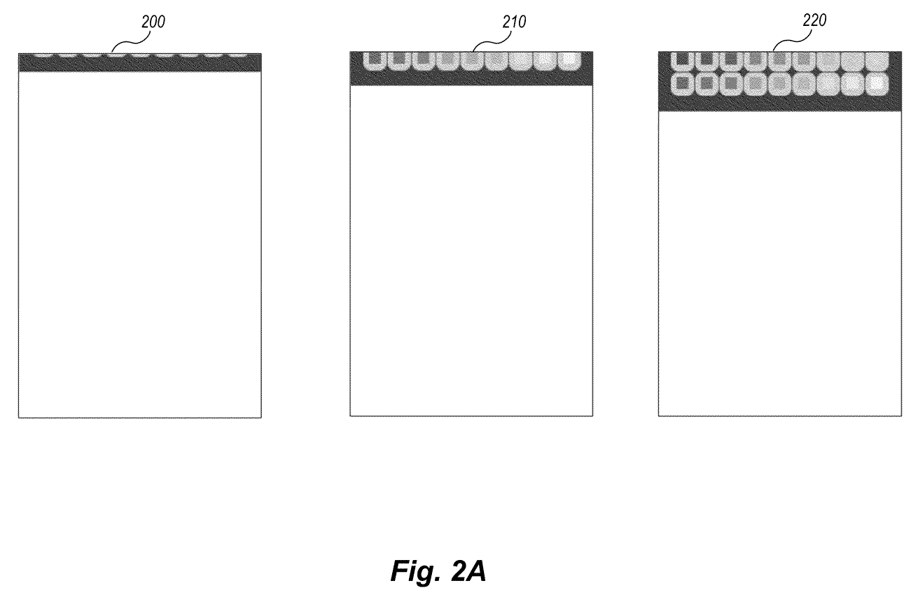

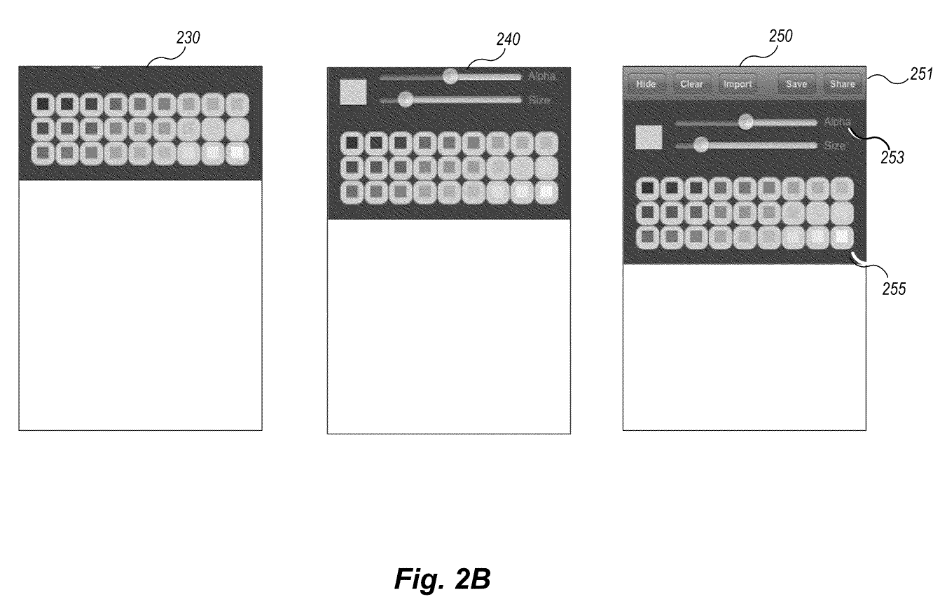

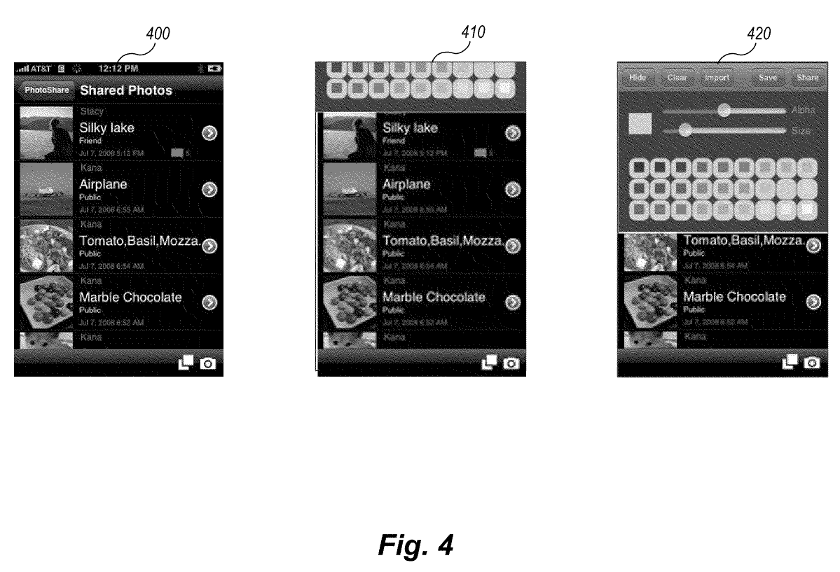

FIGS. 2A and 2B are an example illustration of an opening progression of a tilt-initiated menu user interface according to an example embodiment. The menu user interface open progression shown in FIGS. 2A and 2B may be invoked in the environment illustrated in FIG. 1. Portions of a “menu” interface are progressively unfolded (e.g., opened) on the display screens 200, 210, 220, 230, and 240 until the entire (e.g., complete) menu interface is presented on display screen 250. In the example illustrated, the complete menu interface includes a set of UI control buttons 251, some slider controls 253, and some color controls 255. Other types of menus and other UI controls could be similarly incorporated. As well, the progression of the interface being exposed over time shown in display screens 200, 210, 220, 230, 240, and 250 is meant to exemplify an “animation” that is presented when a user tilts the mobile device in a certain direction and past a certain “expose/open” interface threshold. More or less moments in time could be illustrated as different snapshots could be representative of the progression as well. In example embodiments, the exposed menu interface typically overlays what is already being presented on the display screen, as illustrated in FIG. 4. In other embodiments, the exposed menu interface may replace whatever content is being displayed.

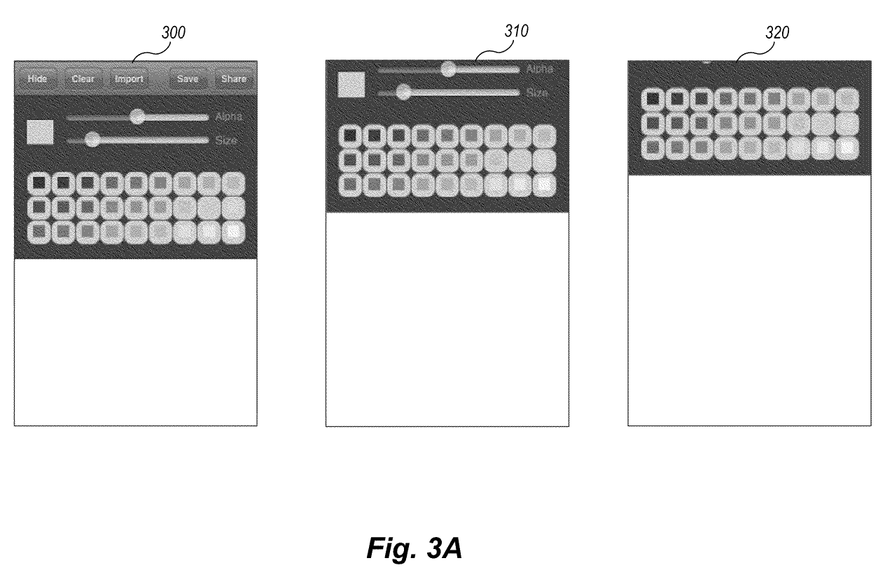

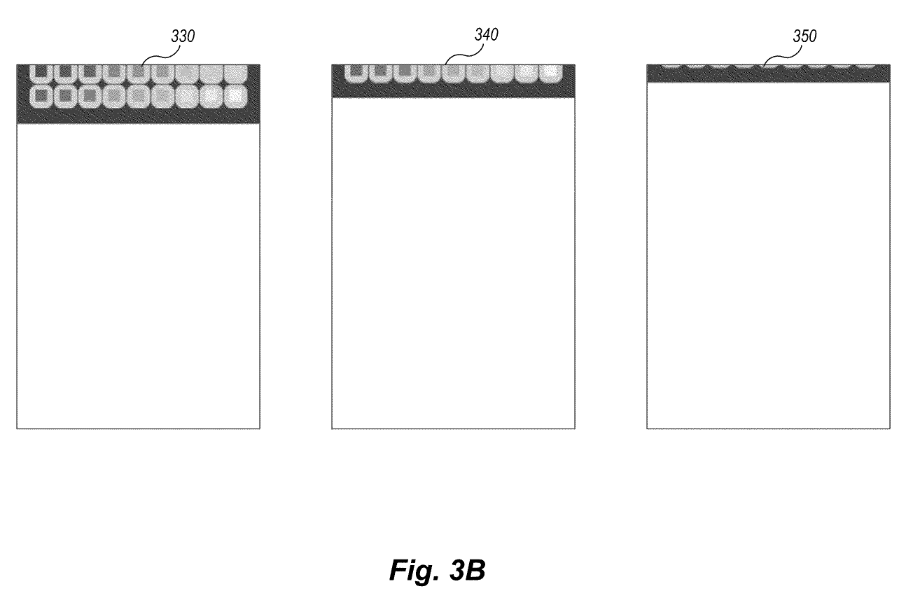

FIGS. 3A and 3B are an example illustration of a closing progression of a tilt-initiated menu user interface according to an example embodiment. The menu user interface close progression shown in FIGS. 3A and 3B may be invoked in the environment illustrated in FIG. 1, and is intended to show the reverse operation to that illustrated in FIGS. 2A and 2B. In particular, portions of a “menu” interface are progressively closed on the display screens 300, 310, 320, 330, and 340 until the a mere “hint” of the menu interface is presented on display screen 350. Note that in some embodiments, there is no hint of the menu interface present on the display screen when the close progression has completed. In other embodiments, a hint or very small portion of the interface (such as menu 350), or some other indication such as a symbol, image, icon, graphic, drawing, etc. may be presented on or in conjunction with the content to indicate to a user that a menu opening operation can be performed. Again, the close progression of the interface over time shown in display screens 300, 310, 320, 330, 340, and 350 is meant to exemplify an “animation” that is presented when a user tilts the mobile device in a certain direction and past a certain “close” interface threshold. More or less moments in time could be illustrated as different snapshots could be representative of the progression as well.

FIG. 4 is an example embodiment of the tilt-initiated menu interface of FIGS. 2A and 2B incorporated within the mobile application environment of FIG. 1. Initially, display screen 400 is shown presenting content of the underlying application, here an application for the sharing of photographs or images. When the user tilts the mobile device “up” past an “expose/open” interface threshold, the menu is progressively opened as shown in display screens 410 and 420. (The in between animations are not illustrated.) When the user tilts the mobile device “down” past a close interface threshold, the menu is closed, as if display screens 420, 410, to 400 are shown in reverse (taking into account whatever user interface modification was engaged as a result of the corresponding UI control presented).

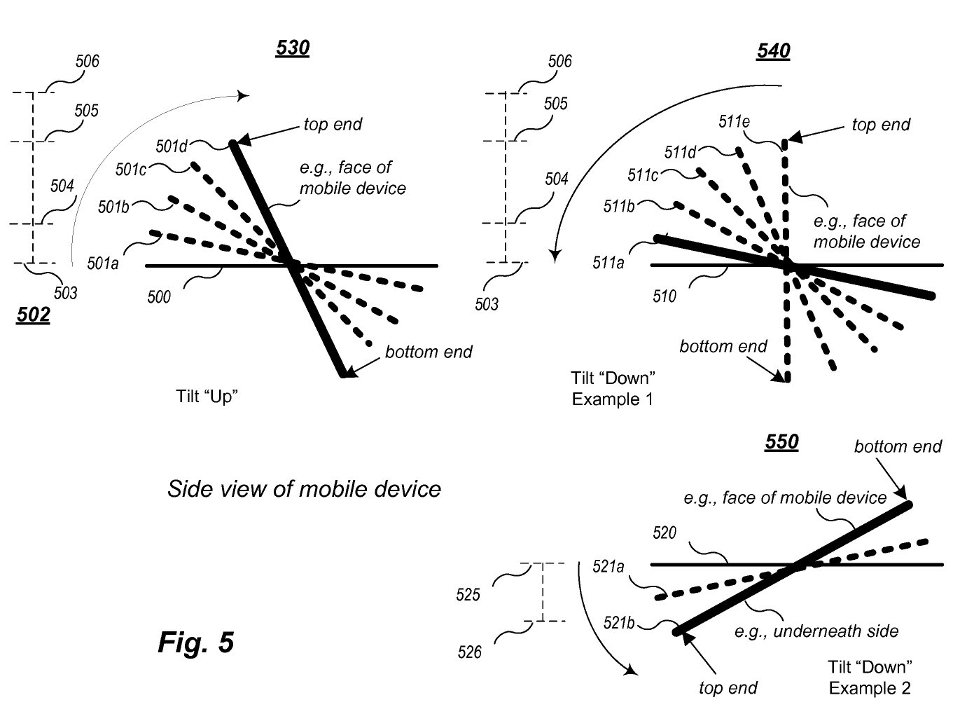

FIG. 5 is an example schematic of tilt movements used to implement aspects of the menu user interface illustrated in FIGS. 2A, 2B, 3A, and 3B. Illustration 530 depicts a mobile device moving from horizontal position 500, progressively through positions 501a-501c until the top end of the device is rotated to (almost) vertical position 501d. This is referred to as a “tilt up” behavior/operation. Similarly, illustration 540 depicts a mobile device moving from vertical position 511e, back through positions 511d-511b, until it reaches (almost) horizontal position 511a. This is referred to as a “tilt down” behavior/operation.

A representation of the abstraction of vertical levels 502 shows how, in illustration 530, as the device tilts up from initial level 503, the device movement crosses close threshold 504 past open threshold 505, to cause a menu to be opened (such as shown in FIGS. 2A and 2B). Level 506 represents the device in a completely vertical position. Similarly, the representation of levels 502 shows how, in illustration 540 as the device tilts down from an initial almost vertical level between levels 505 and 506, the device movement crosses open threshold 505, past close threshold 504, to rest in a position 511a that causes the open menu to be closed(such as shown in FIGS. 3A and 3B). The thresholds 504 and 505 may be expressed as percentages of 506, degrees of tilt, etc. In an example embodiment, the accelerometer's y-axis component assigns a value ‘0’ to the horizontal level 503 and a value of ‘−1’ to the vertical level 506. In this embodiment, the GBUIM uses a close threshold 504 of 20% (−0.2) and an open threshold 505 of 80% (−0.8). Levels between the close threshold 504 and open threshold 505, that is the gap between them, (e.g., −0.2<=y>=−0.8) intentionally do not cause menu action to avoid inadvertent closing or opening of a menu.

Other embodiments may define different threshold levels or different behavior between them. A range of movement that does not produce any action, or that produces a different action, may be similarly applied to other behaviors assigned to tilt up/down motions. In addition, such level measurements may be appropriately defined for the type of accelerometer data received. For example, illustration 550 demonstrates a different example of a tilt down operation, where, the close threshold level 526 is lower relative to horizontal level 525. In this case, in order to close an open menu (or invoke the behavior assigned to a tilt down motion), the device “top” is tilted down (backward) below the horizontal position.

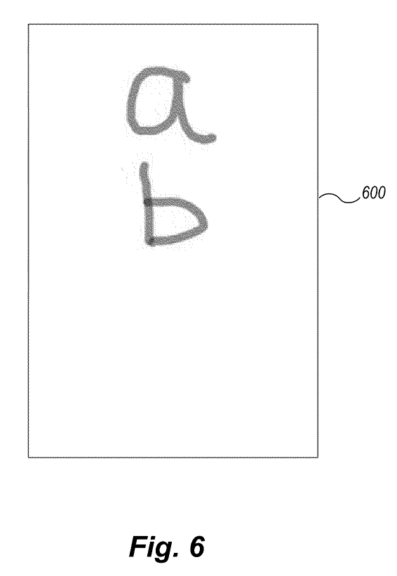

FIG. 6 is an example illustration of an initial user interface display of a mobile application for drawing. In FIG. 6, display screen 600 is shown vertically presenting text string “ab” as content. For the purposes of this example, strokes used to produce text strings are illustrated, however, it is to be understand that an undo/redo operation may be similarly performed on content that does not exclusively include text and on content that may not contain text at all, as long as the underlying application can figure out a unit of content to be undone or redone.

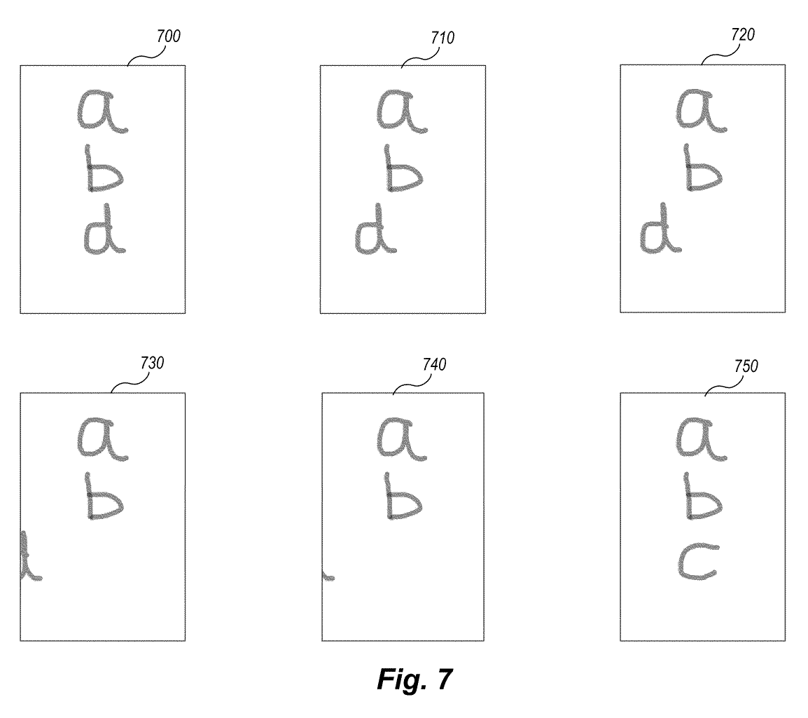

FIG. 7 is an example illustration of a progression of a tilt-initiated user interface for implementing an undo operation. In this example, it is presumed that the user drew a “d” after the string displayed display screen 600 of FIG. 6, resulting in display of the string “abd” in display screen 700, but meant to draw the string “abc.” As the user tilts the left side of the mobile device down, the application using GBUIM techniques progressively causes the last stroke (here a “d” character) to be removed (e.g., discarded, cleared, etc.) from the display screen, as shown in animations 710-740. The user can then draw the intended character “c” to yield string “abc” as shown in display screen 750. The animations of 700-740 are renditions of the content of the display screen of the mobile device over time, and more or less partial displays of the strokes making up the character “d” moving off the display screen may be shown. Different styles of animation, including highlighting and audio effects may also be used to supplement the animation. Also, in some drawing programs, a stroke may be defined differently than in other programs (e.g., multiple strokes may comprise the “d” character animation).

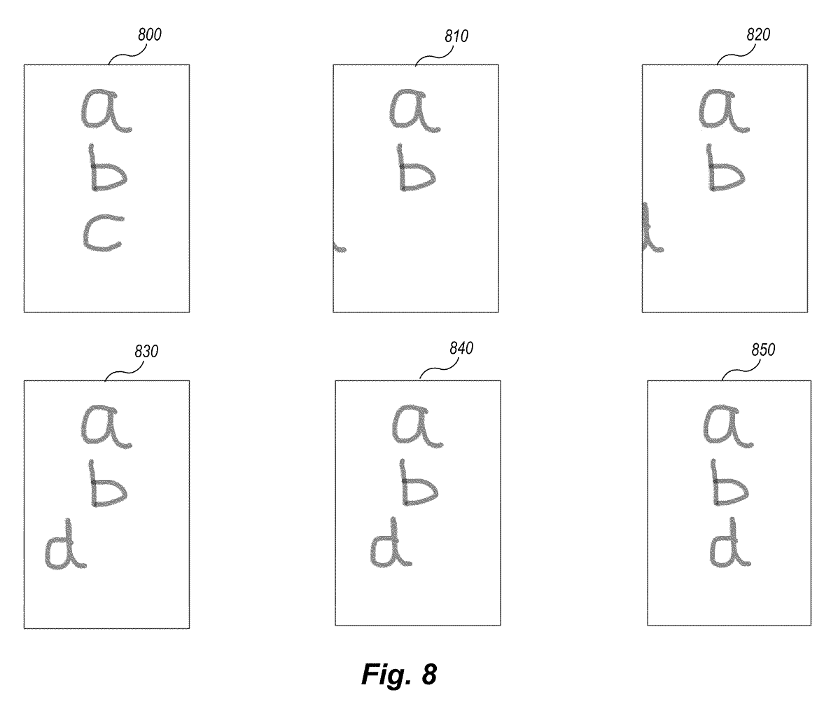

Similarly, the user can tilt the right side of the mobile device down (the opposite rotation) to cause a “redo” operation to again yield string “abd” instead of string “abc.” FIG. 8 is an example illustration of a progression of a tilt-initiated user interface for implementing a redo operation. This progression is demonstrated in animations 810-850 from initial display 800. Again, the animations are renditions of the content of the display screen of the mobile device over time, and more or less partial displays of the strokes making up the character “d” moving back onto the display screen may be shown.

Although not shown, in some embodiments a secondary undo or redo threshold (e.g., a multi-undo or multi-redo threshold) is defined that allows an application to implement a multiple stroke, character (or other unit) undo/redo operation. The secondary undo/redo may provide a repeated stroke undo/redo, thereby alleviating a user needing to engage in multiple tilt operations to undo/redo several strokes at a time. In the example shown in FIG. 7, this may allow a total erasure of the string “abc” to an initial screen displaying nothing.

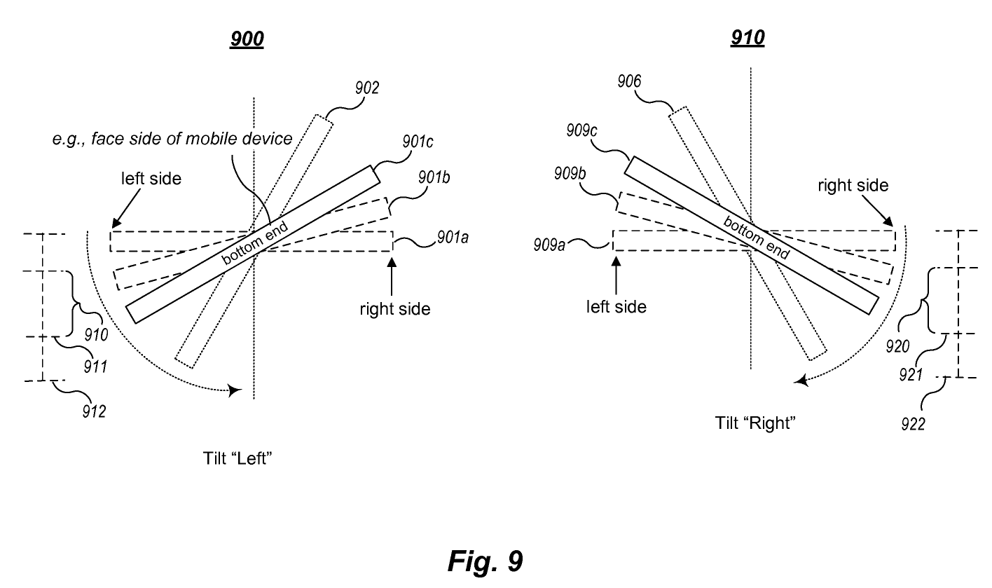

FIG. 9 is an example schematic of tilt movements used to implement aspects of the undo/redo user interface of FIGS. 7 and 8. Illustration 900 depicts a mobile device moving from horizontal position 901a progressively through position 901b to position 901c. This movement is reflective of the left side of the device being rotated downward, thereby causing the right side of the device to accordingly be rotated upward. This is referred to as a “tilt left” behavior/operation. Similarly, illustration 910 depicts a mobile device moving from horizontal position 909a through position 909b, to rest at to position 909c. This movement is reflective of the right side of the device being rotated downward, thereby causing the left side of the device to accordingly be rotated upward. This is referred to as a “tilt right” behavior/operation. Note that the actual starting position of the rotation may have been earlier and may end further rotated. For example, in some example embodiments, when the device is tilted left to position 902, a multiple (e.g., repeated) stroke (character or unit) undo operation may be invoked as described above. Similarly, when the device is tilted right to position 906, a multiple (e.g., repeated) stroke (character or unit) redo operation may be invoked.

A representation of the abstraction of vertical levels 912 next to the tilt left illustration 900 indicates that a tilt left operation may trigger an undo operation when the position of the device falls within the undo area (e.g., within undo range) 910. Further, in some embodiments, when the tilt movement position exceeds the multi-undo threshold 911, the tilt left operation may trigger a repeated stroke/character/unit undo operation as described above with reference to FIG. 7. Similarly, a representation of the abstraction of vertical levels 922 next to the tilt right illustration 910 indicates that a tilt right operation may trigger a redo operation when the position of the device falls with the redo area (e.g., within redo range) 920. Further, in some embodiments, when the tilt movement position exceeds the multi-redo threshold 921, then the tilt right operation may trigger a repeated stroke/character/unit redo operation.

Example embodiments described herein provide applications, tools, data structures and other support to implement a gravity-based user interface mechanism to be used for enhancing the usability of mobile devices, especially those with limited screen real estate or having small profiles. Other embodiments of the described techniques may be used for other purposes, including for user interfaces for gaming consoles that may or may not be associated with smaller display screens. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the code flow, different code flows, etc. Thus, the scope of the techniques and/or functions described are not limited by the particular order, selection, or decomposition of steps described with reference to any particular routine.

Also, although certain terms are used primarily herein, other terms could be used interchangeably to yield equivalent embodiments and examples. For example, it is well-known that equivalent terms could be substituted for such terms as “tilt,” “rotation,” “display,” etc. In addition, terms may have alternate spellings which may or may not be explicitly mentioned, and all such variations of terms are intended to be included.

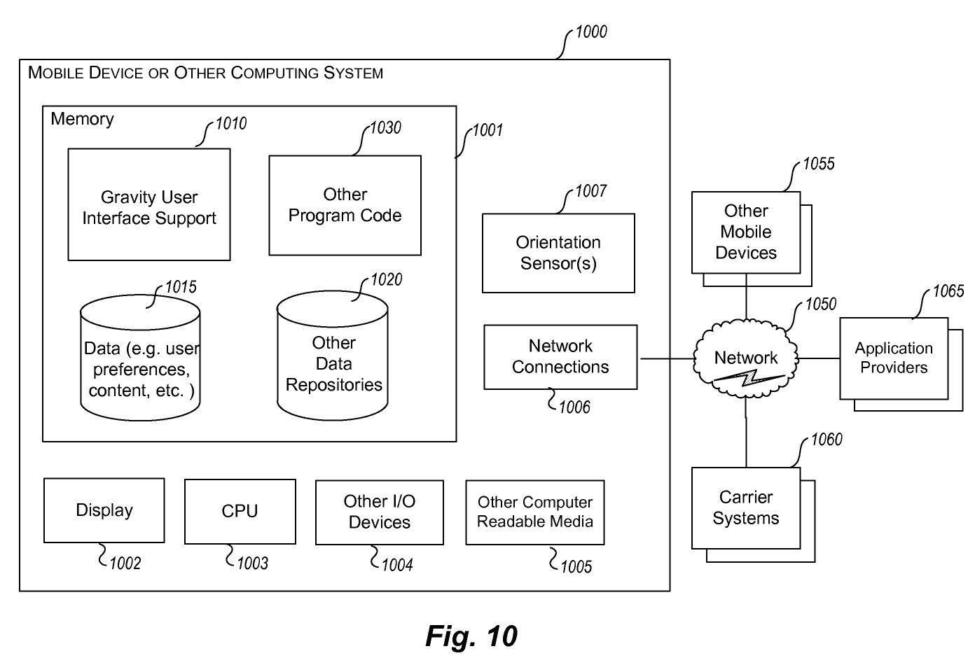

FIG. 10 is an example block diagram of a mobile device or a computing system for practicing embodiments of a gravity-based user interface mechanism. Note that a general purpose or a special purpose mobile device or computing system suitably instructed may be used to implement a GBUIM. Further, the GBUIM may be implemented in software, hardware, firmware, or in some combination to achieve the capabilities described herein.

In a typical implementation, mobile device/computing system 1000 is a standalone mobile device, e.g., a client device, that communicates over a network to one or more other devices, carriers, servers, etc. However, in some embodiments computing system 1000 may comprise one or more computing systems and may span distributed locations. In addition, each block shown in mobile device/computing system 1000 may represent one or more such blocks as appropriate to a specific embodiment or may be combined with other blocks. The various blocks may use standard (e.g., TCP/IP) or proprietary interprocess communication mechanisms to communicate with each other.

In the embodiment illustrated and described, mobile device 1000 comprises a computer memory (“memory”) 1001, a display 1002, one or more Central Processing Units (“CPU”) 1003, other Input/Output devices 1004 (e.g., keyboard, mouse, CRT or LCD display, etc.), other computer-readable media 1005, one or more network connections 1006, and one or more orientation sensors 1007. The GBUIM embodied as a gravity user interface (UI) support module 1010 is shown residing in memory 1001. In other embodiments, some portion of the contents or some of or all of the components/capabilities of the gravity UI support module 1010 may be stored on and/or transmitted over the other computer-readable media 1005. In addition, it will be appreciated that memory 1001 is one type of storage media, and may include many different forms of memory. The gravity UI support module 1010 preferably executes on one or more CPUs 1003 and manages the handling of tilt operations, in response to tilt movements detected by orientation sensors 1007, with respect to the UI preferences and application data 1015, as described herein. Other code or programs 1030 and potentially other data repositories, such as data repository 1020, also reside in the memory 1010, and preferably execute on one or more CPUs 1003. Of note, one or more of the components in FIG. 10 may not be present in any specific implementation.

In a typical embodiment, the gravity UI support module 1010 interacts with data provided by the data repository 1015, which may include, for example, data representing user preferences, and manages events triggered by the orientation sensors 1007, such as an accelerometer. In at least some embodiments, the user preference data 1015 is provided external to the gravity UI support module 1010 and is available, potentially, over one or more networks 1050 or via other systems communicatively coupled to the mobile device 1000. Other modules also may be present to interact with gravity UI support module 1010. In addition, the gravity UI support module may interact via a network 1050 with other client devices 1055 such as other mobile devices, one or more mobile device application providers 1065, and/or one or more carrier systems 1060. Network 1050 may be wireless network such as a telecommunications network and/or comprise a connection to a local or wide area network such as the Internet. In other embodiments not described here, network 1050 may comprise wired data transmissions.

In an example embodiment, the gravity user interface support module 1010 is implemented using standard programming techniques. However, a range of programming languages known in the art may be employed for implementing such example embodiments, including representative implementations of various programming language paradigms, including but not limited to, object-oriented (e.g., Java, C++, C#, Smalltalk, etc.), functional (e.g., ML, Lisp, Scheme, etc.), procedural (e.g., C, Pascal, Ada, Modula, etc.), scripting (e.g., Perl, Ruby, Python, JavaScript, VBScript, etc.), declarative (e.g., SQL, Prolog, etc.), etc.

The embodiments described above may also use well-known or proprietary synchronous or asynchronous computing techniques, or alternately decomposed using a variety of structuring techniques known in the art, including but not limited to, multiprogramming, multithreading, etc. Some embodiments are illustrated as executing concurrently and asynchronously and communicating using message passing techniques. Equivalent synchronous embodiments are also supported. In addition, programming interfaces to the data stored as part of the gravity UI support module 1010 (e.g., the user preference data in the data repositories 1015) can be made available by standard means such as through C, C++, C#, and Java APIs; libraries for accessing files, databases, or other data repositories; through scripting languages such as XML; or through Web servers, FTP servers, or other types of servers providing access to stored data. The data repository 1015 may be implemented as one or more database systems, file systems, XML, or any other method known in the art for storing such information, or any combination of the above, including implementation using distributed computing techniques.

Furthermore, in some embodiments, some or all of the components/functionality of the gravity UI support module 1010 may be implemented or provided in other manners, such as at least partially in firmware and/or hardware, including, but not limited to one ore more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the components, functionality, and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated mobile devices to execute or otherwise use or provide the contents to perform at least some of the described techniques. Some or all of the components, functionality, and data structures may also be transmitted as contents of generated data signals (e.g., by being encoded as part of a carrier wave or otherwise included as part of an analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other device configurations.

As described in FIGS. 1-9, one of the functions of a Gravity-Based User interface mechanism is to intercept and handle device tilt movements.

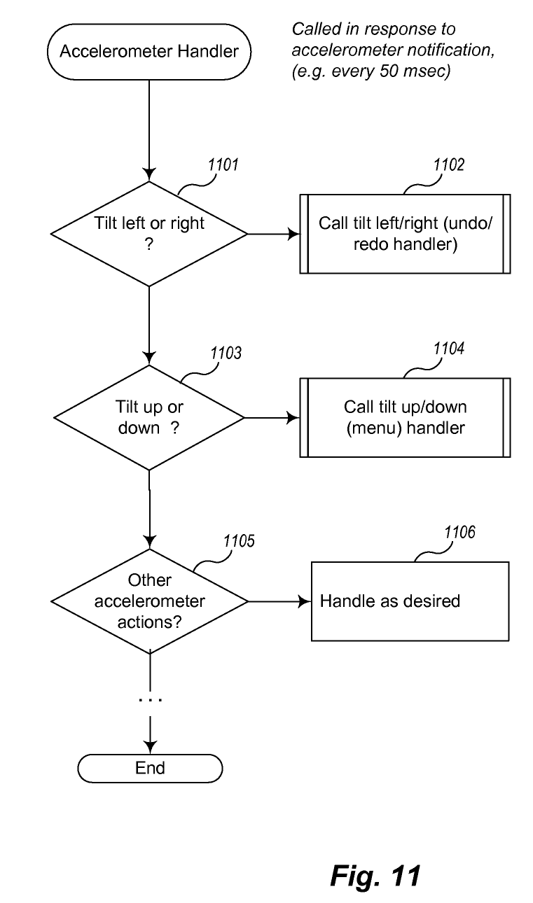

FIG. 11 is an example flow diagram of an example event handler for handling accelerometer events. Such events may be received, for example, from an accelerometer device such as orientation sensor(s) 1007 in FIG. 10. In some embodiments, the event handler may be implemented as an interrupt handler, given programmatic control by some component of the operating system executing on the device. In block 1101, the handler detects whether a tilt “left” or “right” has occurred, and if so, invokes a routine to handle tilt left/right events. In block 1102, the handler detects whether a tilt “up” or “down” has occurred, and if so, invokes a routine to handle tilt up/down, in this case menu, events. In block 1103, the handler detects whether other accelerometer events have occurred, and if so, invokes an appropriate routine to handle them.

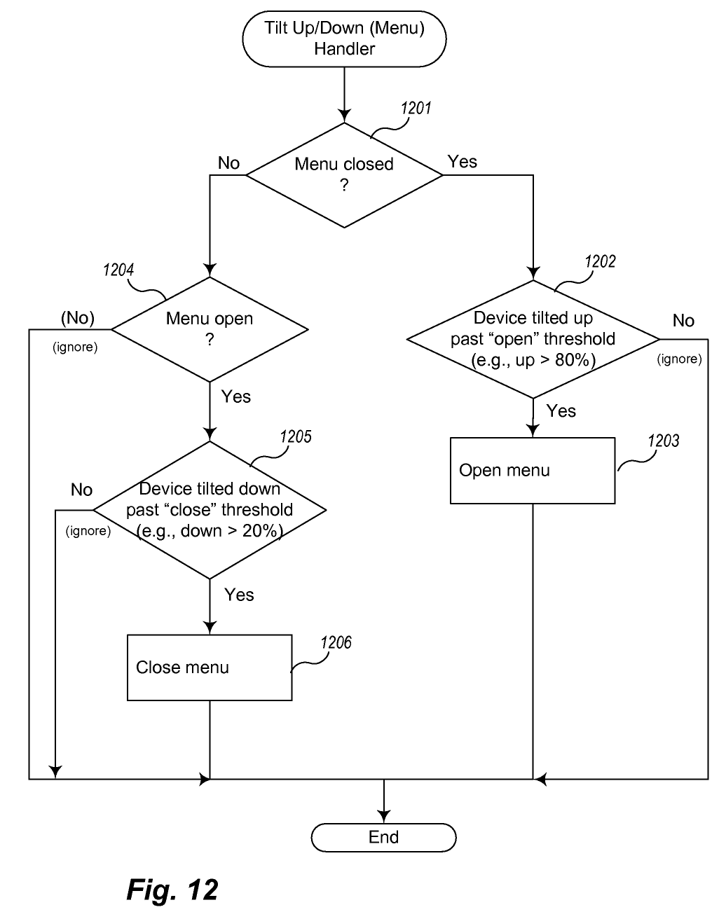

FIG. 12 is an example flow diagram of an example tilt up/down handler for implementing menus according to an example embodiment of a gravity-based user interface. The gravity-based user interface may be implemented, for example, by a gravity UI support module 1010 shown in FIG. 10. As described with reference to FIGS. 2A-5, the tilt up/down handler is described here to implement a menu interface. It will be appreciated that the logic is demonstrated by the blocks of FIG. 12 and that other arrangements that optimize responsiveness for different or particular device structures are equally supported. In block 1201, the handler determines whether the menu is closed, and if so, continues in block 1202, else continues in block 1204. In block 1202, if the device is tilted “up” past the open menu threshold (see, e.g., threshold 505 in FIG. 5), then in block 1203 the menu is presented, sometimes in an animated form such as that shown in FIGS. 2A and 2B. If not then the tilt event is ignored. In block 1204, the handler determines whether the menu is already open, and, if so, continues in block 1205, otherwise ignores the tilt event or handles an error condition. In block 1205, if the device is tilted “down” past the close menu threshold (see, e.g., threshold 504 or threshold 526 in FIG. 5), then in block 1206 the menu is closed, sometimes in an animated form such as that shown in FIGS. 3A and 3B. If not, then the tilt event is ignored. The handler routine then ends. Note that the ignoring of tilt events between (less than) the menu open threshold and (greater than) the menu close threshold allows a user some freedom in tilting the device without worry that the menu will suddenly or inadvertently open or close.

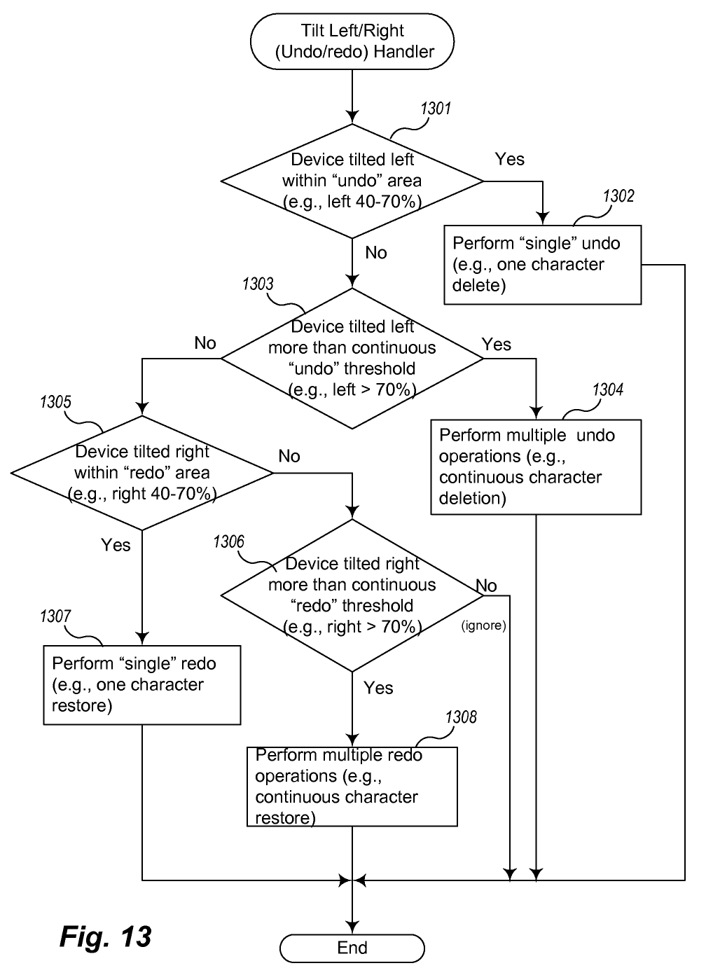

FIG. 13 is an example flow diagram of an example tilt left/right handler for implementing undo/redo operations according to an example embodiment of a gravity-based user interface. The gravity-based user interface may be implemented, for example, by a gravity UI support module 1010 shown in FIG. 10. As described with reference to FIGS. 6-9, the tilt left/right handler is described here to implement an undo/redo interface. It will be appreciated that one flow of logic is demonstrated by the blocks of FIG. 13 and that other arrangements that optimize responsiveness for different or particular device structures are equally supported. In block 1301, the handler determines whether the device has been tilted “left” within an undo area/range (see, e.g., undo area 910 in FIG. 9), and if so, continues in block 1302 to execute an undo operation (e.g., a single character or unit undo operation), else continues in block 1303. In block 1303, the handler determines whether the device has been tilted left past the undo threshold (see, e.g., multi-undo threshold 911 in FIG. 9), and if so, continues in block 1304 to execute a multi-character/unit undo operation, else continues in block 1305. In block 1305, the handler determines whether the device has been tilted “right” within a redo area/range (see, e.g., redo area 920 in FIG. 9), and if so, continues in block 1307 to execute a redo operation (e.g., a single character or unit redo operation), else continues in block 1306. In block 1306, the handler determines whether the device has been tilted right past the multi-redo threshold (see, e.g., multi-redo threshold 921 in FIG. 9), and if so, continues in block 1308 to execute a multi-character/unit redo operation, otherwise the tilt event is ignored. The handler routine then ends. Note that the ignoring of tilt events that are between the beginning of the undo and redo areas allows a user some freedom in tilting the device without worry that an undo or redo operation will suddenly or inadvertently occur.

All of the above U.S. patents, U.S. patent application publications, U.S. patent applications, foreign patents, foreign patent applications and non-patent publications referred to in this specification and/or listed in the Application Data Sheet are incorporated herein by reference, in its entirety.

From the foregoing it will be appreciated that, although specific embodiments have been described herein for purposes of illustration, various modifications may be made without deviating from the spirit and scope of the present disclosure. For example, the methods, systems, and techniques for processing tilt operations discussed herein are applicable to other architectures other than an Apple iPhone architecture. Also, the methods, systems, and techniques discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, etc.).

1. A mobile telecommunications device, comprising:
a display;
a memory;
an accelerometer; and
a gravity based user interface module, stored on the memory, and configured when executed to:
receive an indication from the orientation sensor that a tilt event has occurred;
determine whether the tilt event is associated with motion along a transverse axis or a longitudinal axis of the mobile device;
when it is determined that the associated motion is along the transverse axis,
determine whether the associated motion has tilted the device upwards past an open threshold and, when so, present a user interface menu on the display if the menu is not already displayed; and
determine whether the associated motion has tilted the device downward below a close threshold and, when so, close the user interface menu presented on the display; and
when it is determined that the associated motion is along the longitudinal axis,
determine whether the associated motion has tilted the device left within an undo area and, when so, cause performance of an undo operation to affect output presented on the display; and
determine whether the associated motion has tilted the device right within a redo area and, when so, cause performance of a redo operation to affect output presented on the display.

2. The device of claim 1, wherein the undo operation causes a portion of the output presented on the display to be removed and wherein the redo operation causes a previously presented portion of output to again be presented on the display.

3. The device of claim 1 wherein the user interface menu is presented and/or closed using a series of animations to show the menu gradually appearing or respectively disappearing.

4. The device of claim 1 wherein the undo and/or redo operations use animations to gradually show the portion of the output being removed or presented, respectively.

5. A mobile computing device comprising:
an associated display;
a memory;
an orientation sensor; and
an orientation sensitive user interface module, stored on the memory, and configured when executed to:
receive an indication from the orientation sensor that a tilt event along a transverse or a longitudinal axis of the device has occurred has occurred; and
in response to the received indication, cause at least one of a menu open operation, a menu close operation, an undo operation, or a redo operation to occur, thereby affecting output presented on the associated display.

6. The device of claim 5 wherein the orientation sensor is an accelerometer.

7. The device of claim 5 wherein the orientation sensitive user interface module is configured to cause the menu open operation when the indicated tilt event reflects motion of the device upwards past an open threshold and to cause the menu close operation when the indicated tilt event reflects motion of the device downwards below a close threshold.

8. The device of claim 7 wherein the orientation sensitive user interface module is configured to not cause a menu operation when the indicated tilt event reflects motion of the device between the open threshold and the close threshold.

9. The device of claim 7 wherein the open threshold occurs at 80 percent tilt of 90 degree directional movement of the top of the device, measured upward from a horizontal to a vertical position.

10. The device of claim 7 wherein the close threshold occurs at 20 percent tilt of 90 degree directional movement of the top of the device, measured upward from a horizontal to a vertical position.

11. The device of claim 5 wherein the orientation sensitive user interface module is configured to cause the undo operation when the indicated tilt event reflects motion of the device to one side within an undo tilt area and to cause the redo operation when the indicated tilt event reflects motion of the device to another side opposite the one side within a redo tilt area.

12. The device of claim 11 wherein the undo tilt area occurs between 40 and 70 percent tilt of 90 degree directional movement of the side of the device moving from a horizontal to a downward vertical position.

13. The device of claim 11 wherein the redo tilt area occurs between 40 and 70 percent tilt of 90 degree directional movement of the another side of the device moving from a horizontal to a downward vertical position.

14. The device of claim 5 wherein the device is a touch screen telecommunications device.

15. The device of claim 5 wherein the open menu operation, the close menu operation, the undo operation, or the redo operation result in an animation on the associated display.

16. The device of claim 5 wherein the device is a mobile telecommunications device.

17. A computer-readable medium containing computing instructions that cause a mobile computing device to open or close a user interface menu operation or to perform an undo/redo operation in relation to content displayed on a display screen associated with the computing device, by performing a method comprising:
receiving an indication from an orientation sensor that a tilt event along a transverse or a longitudinal axis of the device has occurred; and
in response to the received indication, causing at least one of a menu open operation, a menu close operation, an undo operation, or a redo operation to occur, thereby affecting output presented on the display screen.

18. The computer-readable medium of claim 17, the method further comprising:
when the tilt event indicates a first amount of tilt, causing a first operation to occur; and
when the tilt event indicates a second amount of tilt different from the first amount, cause a second operation that is unique from the first operation to occur.

19. The computer-readable medium of claim 18, wherein the first amount of tilt and second amount of tilt occur along the same rotational axis.

20. The computer-readable medium of claim 17, the method further comprising:
causing a menu to be presented on the display screen when the tilt event indicates a tilt up motion of the device past an open menu threshold; and
causing a menu presented on the display screen to be removed from display when the tilt event indicates a tilt down motion of the device past a close menu threshold.

21. The computer-readable medium of claim 20 wherein the menu is presented on or removed from the display screen in an animated sequence.

22. The computer-readable medium of claim 20, the method comprising:
removing content already displayed on the display screen prior to causing the menu to be presented.

23. The computer-readable medium of claim 20, the method comprising:
causing the menu to be presented in a manner that overlays content previously displayed on the display screen.

24. The computer-readable medium of claim 17, the method further comprising:
causing an undo operation to affect output on the display screen when the tilt event indicates a tilt motion of one side of the device within a first tilt area; and
causing a redo operation to affect output on the display screen when the tilt event indicates a tilt motion of an opposite side of the device within a second tilt area.

25. The computer computer-readable medium of claim 24 wherein the tilt motion of one side is a tilt left motion and the tilt motion of the opposite side is a tilt right motion.

26. The computer-readable medium of claim 24, the method further comprising:
causing a repeated undo operation to affect output on the display screen when the tilt event indicates a tilt motion of the one side of the device past a first threshold; and
causing a repeated redo operation to affect output on the display screen when the tilt event indicates a tilt motion of the opposite side of the device past a second threshold.

27. The computer-readable medium of claim 26 wherein the output is composed of strokes and the undo or redo operation animates the gradual placement or removal of a stroke from the output displayed.

28. The computer-readable medium of claim 17 wherein the medium is embedded in a mobile telecommunications device.

29. The computer-readable medium of claim 28 wherein the mobile telecommunications device is a cellular telephone, a smart phone, or a wireless personal digital assistant device.

30. The computer-readable medium of claim 17 wherein the medium is a memory of the mobile computing device and the contents are computer instructions that are executed by a processor of the computing device to perform the method.

31. A method in a computing device for providing a gravity based user interface, comprising:
under control of the computing device,
receiving an indication from an orientation sensor that a tilt event along a transverse or a longitudinal axis of the device has occurred; and
in response to the received indication, causing at least one of a menu operation or an undo/redo operation to occur affecting output presented on a display screen associated with the computing device.

32. The method of claim 31 wherein the orientation sensor is an accelerometer.

33. The method of claim 31 wherein, when the received indication indicates that a tilt event along the transverse axis of the device has occurred thereby signaling a tilt up or tilt down motion, causing a menu to appear or disappear.

34. The method of claim 31 wherein, when the received indication indicates that a tilt event along the longitudinal axis of the device has occurred thereby signaling a tilt left or tilt right motion, causing an undo or redo operation to occur.

35. The method of claim 34 wherein the tilt left or tilt right motion indicates a tilt downward below a predetermined threshold, and further comprising:
correspondingly causing a repeated undo or redo operation to occur.

36. The method of claim 31 wherein the receiving the indication from the orientation sensor that the tilt event has occurred further comprises:
receiving an indication from the orientation sensor that a first tilt event along one of the transverse axis or the longitudinal axis of the device has occurred and causing a first operation to be performed; and
receiving an indication from the orientation sensor that a second tilt event along the same axis of the device has occurred, thereby signaling a further tilt in the same direction, and causing a second operation to be performed.

37. The method of claim 31 wherein the computing device is a mobile phone.

38. The method of claim 31 wherein the computing device is a game console.
